(19) United States
(12) Patent Application Publication
(10) Pub. No.: US 2014/0353444 A1
(43) Pub. Date: Dec. 4, 2014

(54) FIXING APPARATUS FOR HARD DISK DRIVE

(71) Applicant: HON HAI PRECISION INDUSTRY CO., LTD., New Taipei (TW)

(72) Inventor: CHIH-HUA CHEN, New Taipei (TW)

(73) Assignee: HON HAI PRECISION INDUSTRY CO., LTD., New Taipei (TW)

(21) Appl. No.: 14/294,276

(22) Filed: Jun. 3, 2014

(30) Foreign Application Priority Data
Jun. 3, 2013 (TW) 102119663

(51) Int. Cl. G06F 1/18

(52) U.S. Cl. CPC G06F 1/187
USPC 248/205.1

(57) ABSTRACT

A fixing apparatus for fixing a hard disk drive includes a first frame, a second frame, and a latching device. The first frame includes a first mounting arm and a first connecting arm. The first mounting arm includes a number of fixing columns for inserting into fixing holes of the hard disk drive. The first connecting arm defines a hole. The first connection arm defines an elongated slot on an outer surface thereof, and the elongated slot defines an inclined slot beside the hole. The second frame includes a second mounting arm and a second connecting arm, which is slidably received in the elongated slot. The latching device is attached to the second frame and, includes a pressing member, which can slide along the inclined slot and insert into or withdraw from the hole. A spring is provided between the pressing member and the second connecting arm.

### FIELD

The present disclosure relates to fixing apparatuses, and particularly to a fixing apparatus for hard disk drives (HDDs).

### BACKGROUND

Hard disk drives (HDDs) may be mounted in a computer chassis by screwing the HDD to a drive bracket, and mounting the HDD and the bracket in a computer chassis.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an embodiment of a fixing apparatus together with an HDD.

FIG. 2 is an exploded, isometric view of the fixing apparatus of FIG. 1, viewed from a different aspect.

FIG. 3 is an exploded, isometric view of a latching device of the fixing apparatus.

FIG. 4 is an assembled isometric view of FIG. 1, showing the fixing apparatus in a locked state.

FIG. 5 is a cross-sectional view of FIG. 4, taken along line V-V.

FIG. 6 is similar to FIG. 4, but showing the fixing apparatus in an unlocked state.

FIG. 7 is a cross-sectional view of FIG. 6, taken along line VII-VII.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

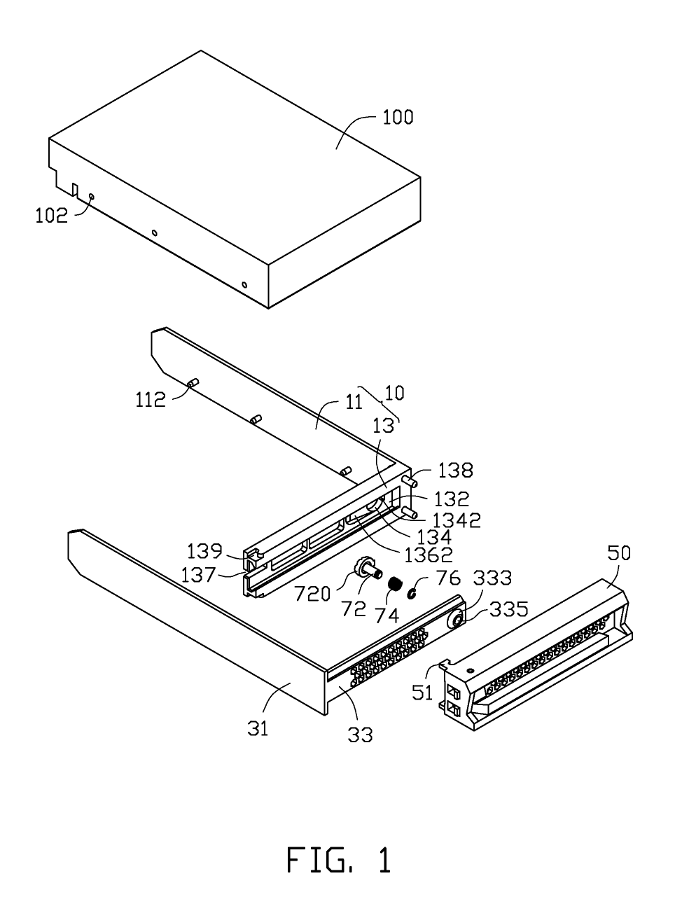

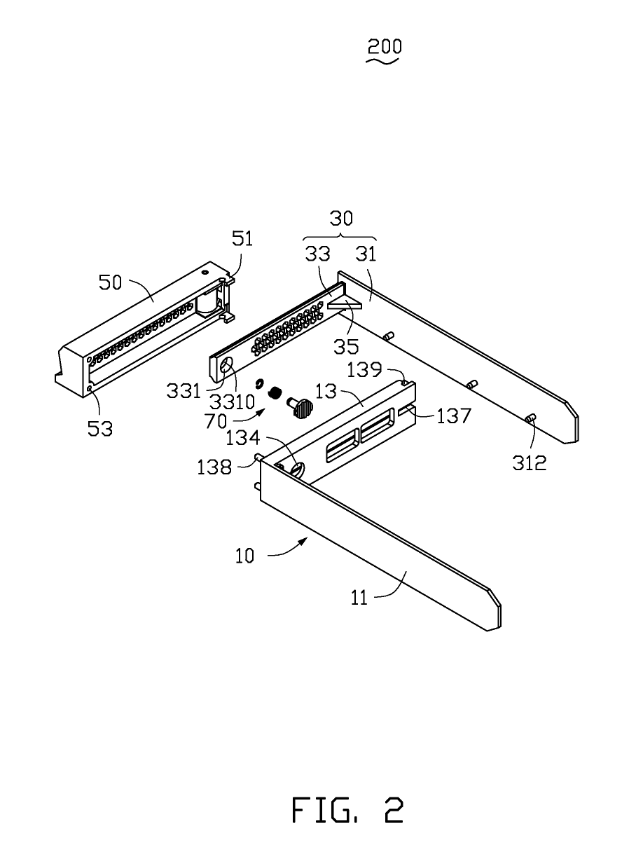

FIGS. 1 and 2 illustrate an embodiment of a fixing apparatus 200 for fixing a hard disk drive (HDD) 100. The fixing apparatus 200 includes a first frame 10, a second frame 30, a bezel member 50, and a latching device 70.

The HDD 100 defines a plurality of fixing holes 102 in two opposite sidewalls thereof.

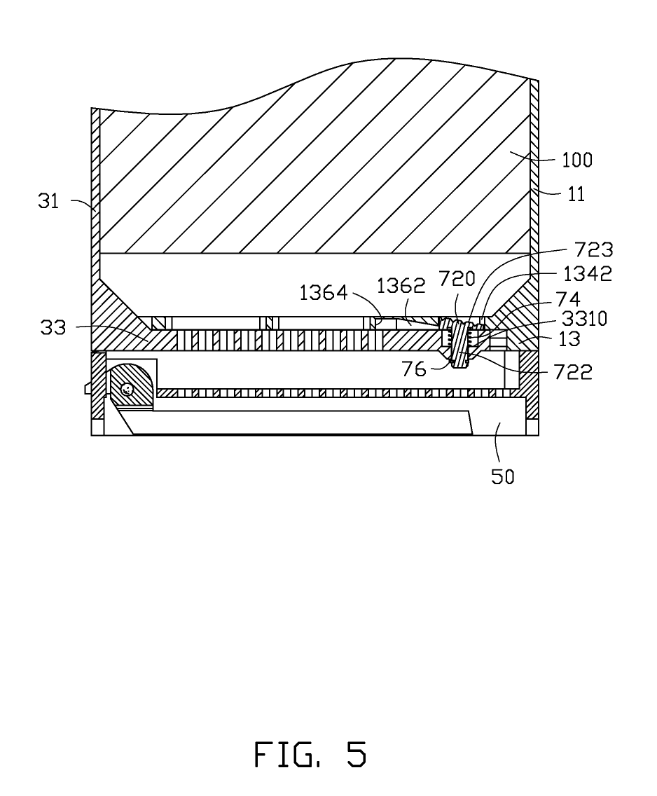

In the illustrated embodiment, the first frame 10 is substantially L-shaped and includes a first mounting arm 11 and connected substantially perpendicularly to a first connecting arm 13. A plurality of fixing columns 112, corresponding to the plurality of fixing holes 102 of one sidewall of the HDD 100, extends from an inner surface of the first mounting arm 11. An outer surface of the first connection arm 13 defines an elongated recessed portion 132. A first through hole 134 is defined in the first connection arm 13 inside of the recessed portion 132 and located adjacent to the first mounting arm 11. The back wall of the recessed portion 132 further defines a fixing slot 1342 extending from the first through hole 134. A portion of the back wall of the recessed portion 132 bordering the first through hole 134 is further gradually inclined away from the through hole 134 to form an inclined wall 1362. A distal end of the inclined wall 1362 away from the first through hole 134 forms a blocking wall 1364 (shown in FIG. 5). A middle portion of the end of the first connection arm 13 defines a receiving slot 137. A cutout 139 is defined in a top portion and a bottom portion of the distal end portion of the first connection arm 13. Two fixing posts 138 extend from the outer surface of the first mounting arm 11. The fixing posts 138 are located adjacent to the first mounting arm 11.

In the illustrated embodiment, the second frame 30 is substantially L-shaped and includes a second mounting arm 31, and connected substantially perpendicularly to a second connecting arm 33. A plurality of fixing columns 312 corresponding to the fixing holes 102 of the other sidewall of the HDD 100 extends from an inner surface of the second mounting arm 31. An inner surface of the second connecting arm 33 defines a notch 331 in a distal end portion thereof. A bottom wall of the notch 331 forms a blocking surface 3310. An outer surface of the second connecting arm 33 includes a protrusion 333 protruding from a distal end portion thereof. The protrusion 333 defines a second through hole 335 extending through the blocking surface 3310 of the notch 331. The second frame 30 includes a rib plate 35 connected at a joint of the second mounting arm 31 and the second connecting arm 33.

A first end portion of the bezel member 50 includes a pair of hooks 51. One hook 51 extends from a top portion of the bezel member 50, and one hook 51 extends from a bottom portion of the bezel member 50. The hooks 51 can latch in the cutouts 139 of the first frame 10. Two latching holes 53 are defined in a second end portion of the bezel member 50.

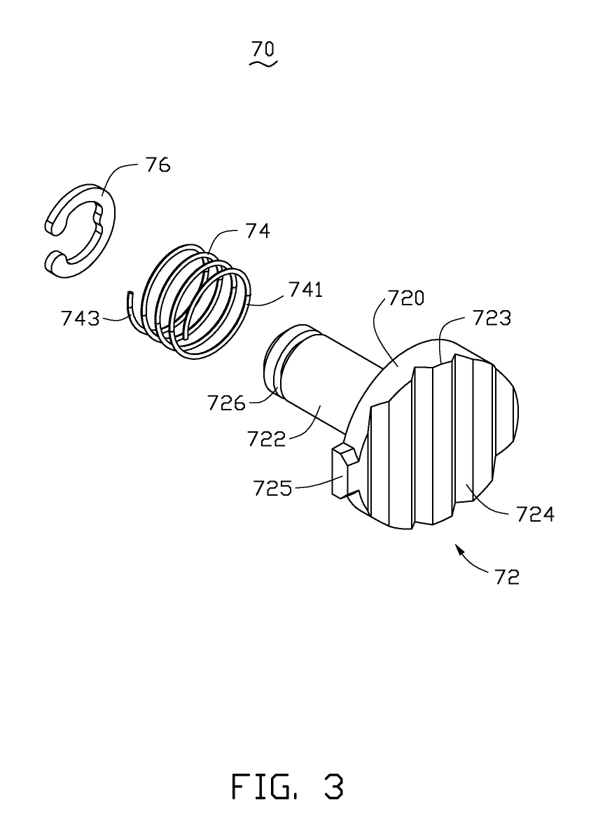

FIG. 3 illustrates that the latching device 70 includes a pressing member 72, a spring 74, and a gasket 76. The pressing member 72 includes a head portion 720 and a stem portion 722 extending substantially perpendicularly from a surface of the head portion 720. The head portion 720 includes an inclined engaging wall 723 formed on a surface thereof away from the stem portion 722. A plurality of ridge patterns 724 is formed on the engaging wall 723, and a blocking tab 725 extends from a side of the head portion 720 to be received in the fixing slot 1342. A distal end portion of the stem portion 722 defines an annular slot 726.

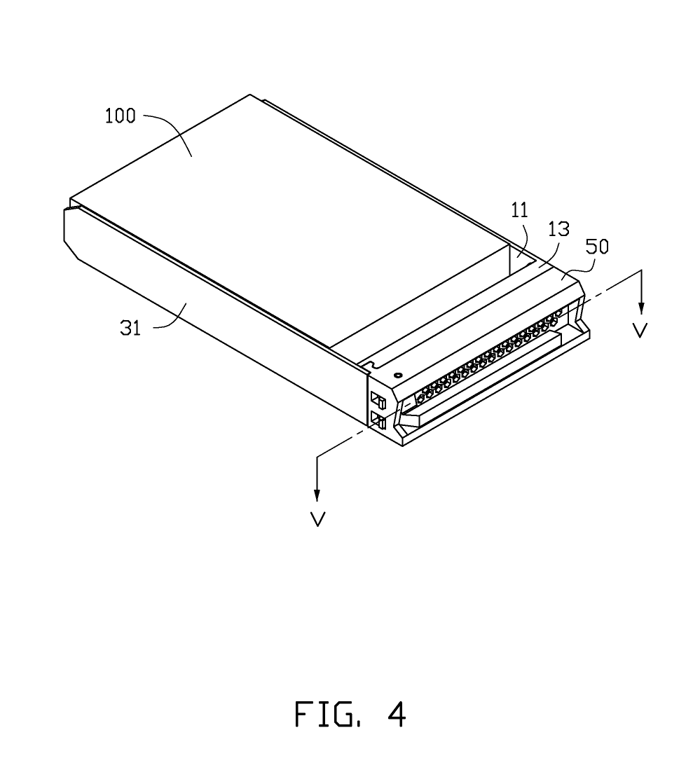

FIGS. 4 and 5 illustrated an assembled fixing apparatus 200. The second connecting arm 33 of the second frame 30 is slidably inserted into the elongated recessed portion 132 of the first connecting arm 13. The rib plate 35 protrudes through the receiving slot 137. The spring 74 is sleeved on the stem portion 722 of the pressing member 72, and the stem portion 722 is passed through the notch 331 and the second through hole 335 from the inner surface of the second connecting arm 33. A first end 743 of the spring 74 is coupled to the blocking wall 3310, and a second end 741 of the spring 74 is coupled to the head portion 720 of the pressing member 72. After the stem portion 722 is passed through the notch 331 and the second through hole 335, the gasket 76 is clamped into the annular slot 726 to prevent the pressing member 72 from being removed from the notch 331 and the second through hole 335. The fixing columns 138 of the first connecting arm 13 of the frame 10 are received in the corresponding latching holes 53 of the bezel member 50, and the hooks 51 of the bezel member 50 are latched in the corresponding cutouts 139 of the first connection arm 13, thereby attaching the bezel member 50 to the first connecting arm 13. The head portion 720 of the pressing member 72 is received in the first through hole 134, and the blocking tab 725 is received in the fixing slot 1342.

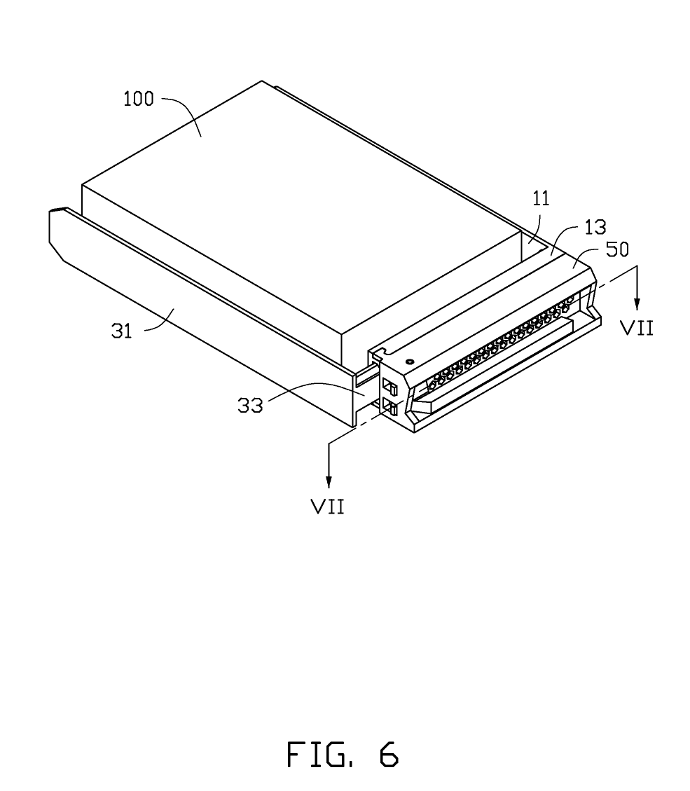

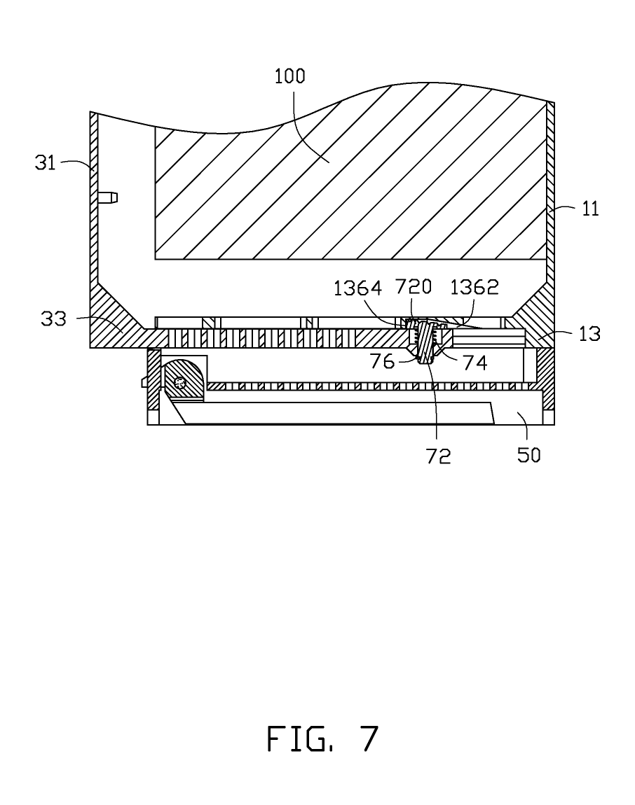

FIGS. 6 and 7 illustrate fixing the HDD 100 in the fixing apparatus 200. The head portion 720 of the pressing member 72 is pushed in a direction toward the bezel member 50 to be released from the first through hole 134, thereby deforming the spring 74. While the head portion 720 of the pressing member 72 is released from the first through hole 134, the bezel member 50 and the first frame 10 are pulled away from the second mounting arm 31 of the second frame 30, until the head portion 720 is blocked by the blocking wall 1364. Then, the HDD 100 is placed between the first mounting arm 11 and the second mounting arm 31, such that the fixing columns 112 of the first mounting arm 11 are received in the fixing holes 102 of the corresponding sidewall of the HDD 100. The second mounting arm 31 is pushed toward the first mounting arm 11 until the spring 74 biases the head portion 720 back into the first through hole 134. The fixing columns 112 of the second frame 30 are received in the fixing holes 102 of the corresponding sidewall of the HDD 100. Thus, the HDD 100 can be conveniently fixed in the fixing apparatus 200.

To detach the HDD 100 from the fixing apparatus 200, the head portion 720 of the pressing portion 72 is pressed to release the head portion 720 from the first through hole 134. Then, the first frame 10 and the bezel member 50 are pulled away from the second frame 30, until the fixing columns 112 of the first frame 10 are removed from the fixing holes 102 of the corresponding sidewall of the HDD 100. Thus, the HDD 100 can be conveniently removed from the fixing apparatus 200.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A fixing apparatus for fixing a hard disk drive (HDD) with a plurality of fixing holes defined in two sidewalls thereof, the fixing apparatus comprising:
a first frame comprising a first mounting arm and a first connecting arm connected substantially perpendicularly to the first mounting arm, the first mounting arm comprising a plurality of fixing columns corresponding to the fixing holes of the HDD, the first connection arm comprising an elongated recessed portion defined in outside thereof, a first through hole defined in the recessed portion, an inclined wall formed at a back wall of the recessed portion bordering the first through hole;
a second frame comprising a second mounting arm and a second connecting arm connected substantially perpendicularly to the second mounting arm, the second mounting arm comprising a plurality of fixing columns corresponding to the fixing holes of the HDD, the second connecting arm slidably received in the recessed portion; and
a latching device attached to the second connecting arm, and comprising a pressing member capable of sliding along the inclined wall to be received into or released from the first through hole, a spring arranged between the pressing member and the second connecting arm, and a gasket coupled to the pressing member and blocked by the second connecting arm.

2. The fixing apparatus of claim 1, wherein the second frame comprises a rib plate connecting at a joint of the second mounting arm and the second connecting arm, the first connection arm forms a receiving slot configured to receive the rib plate.

3. The fixing apparatus of claim 1, wherein the first through hole of the first connection arm is adjacent to the first mounting arm, the second connecting arm comprises a notch formed in an end portion thereof; the second connecting arm comprises a protrusion protruding from a distal end portion thereof, the protrusion forms a second through hole coupled to the notch.

4. The fixing apparatus of claim 3, wherein the pressing member comprises a head portion and a stem portion extending perpendicularly from a surface of the head portion, the stem portion defines an annular slot, the stem portion with the spring is passed through the notch and the second through hole, and the gasket is clamped into the annular slot.

5. The fixing apparatus of claim 4, wherein the recessed portion comprises a blocking wall formed at an end of the inclined wall, for blocking the head portion of the pressing member.

6. The fixing apparatus of claim 5, wherein the head portion of the pressing member comprises an inclined engaging wall formed on a surface thereof away from the stem portion, and a plurality of ridge patterns are formed at the engaging wall.

7. The fixing apparatus of claim 6, wherein a blocking tab extends from the head portion of the pressing member; the first connecting arm comprises a fixing slot defined in the back wall of the recessed portion and coupled with the first through hole of the first connecting arm; and the blocking tab of the pressing member is received in the fixing slot .

8. The fixing apparatus of claim 1, wherein the first connecting arm comprises two cutouts respectively defined in a top portion and the bottom portion thereof, the bezel member comprises a pair of hooks respectively extending from a top portion and a bottom portion thereof to be latched in the cutouts.
